(19) United States
(12) Patent Application Publication
(10) Pub. No.: US 2011/0203817 A1
(43) Pub. Date: Aug. 25, 2011

(54) TRAIL GROOMING DEVICE

(76) Inventor: Todd Hanson, Merrifield, MN (US)

(21) Appl. No.: 13/030,367

(22) Filed: Feb. 18, 2011

Related U.S. Application Data
(60) Provisional application No. 61/338,530, filed on Feb. 19, 2010.

(51) Int. Cl. A01B 49/02; A01B 31/00; A01B 35/20

(52) U.S. Cl. 172/150; 172/170; 172/684.5

(57) ABSTRACT

A trail grooming device connectable to a towing vehicle so that the towing vehicle can pull the device over a surface includes a connection assembly that connects the device to the vehicle; a cutting bed to cut, level and process the surface and with a front portion connected to the connection assembly; a suspension system coupled to the cutting bed to raise or lower the cutting bed; a rear assembly connected to a rear portion of the cutting bed; and a roller connected to the rear assembly to compact the surface after the cutting bed has cut, leveled and processed the surface.

### CROSS-REFERENCE TO RELATED APPLICATION(S)

The present U.S. utility patent application claims the benefit of U.S. provisional application No. 61/281,117 filed on Feb. 19, 2010, which is incorporated herein by reference.

### BACKGROUND

The present invention is related to trail grooming devices.

The term “grooming” refers to a process in which various imperfections (e.g., uneven surfaces, bumps, etc.) are removed to provide a suitable or groomed surface. For example, snow and/or dirt paths often require grooming to provide level, safe paths for winter travel and recreational pursuits, such as snowmobiling, skiing, dogsled racing and kite-skiing/boarding. Grooming may include cutting moguls and high spots off trails, leveling or filling in voids and compacting or squeezing out air in the snow. This can be done in a variety of different ways, including simply plowing the snow on the path or dragging a device over the path for grooming. When a device is drug over the path for grooming, it often needs a powerful vehicle to provide the amount of power needed to groom snow, ice and/or dirt from trails.

### SUMMARY

A trail grooming device connectable to a towing vehicle so that the towing vehicle can pull the device over a surface includes a connection assembly that connects the device to the vehicle; a cutting bed to cut, level and process the surface and with a front portion connected to the connection assembly; a suspension system coupled to the cutting bed to raise or lower the cutting bed; a rear assembly connected to a rear portion of the cutting bed; and a roller connected to the rear assembly to compact the surface after the cutting bed has cut, leveled and processed the surface.

### BRIEF DESCRIPTION OF THE DRAWINGS

FIG. 1 is a perspective view of a trail grooming device according to an embodiment of the present invention attached to a towing vehicle.

FIG. 2 is a perspective view of a trail grooming device according to an embodiment of the present invention.

FIG. 3 is a view from a different perspective of the trail grooming device of FIG. 2, according to an embodiment of the present invention.

FIGS. 4-5 are perspective views of a cutting bed of the trail grooming device of FIG. 2 in a lowered position and a semi-raised position, respectively, according to an embodiment of the present invention.

FIG. 6 is a perspective view of a roller and miniature V-cutters of the trail grooming device of FIG. 2 according to an embodiment of the present invention.

FIG. 7 is a perspective view of an extension wing for attachment to a finishing bar of the trail grooming device of FIG. 2 according to an embodiment of the present invention.

FIGS. 8-9 are perspective views of the hinge action of the hitch assembly of the trail grooming device of FIG. 2 according to an embodiment of the present invention.

FIGS. 10-11 are perspective views showing the location and geometry of V-cutters employed by the trail grooming device of FIG. 2 according to an embodiment of the present invention.

FIG. 12 is a perspective view of the rear frame winch of the trail grooming device of FIG. 2 for raising and lowering the rear of the cutting bed according to an embodiment of the present invention.

FIG. 13 is a perspective view of the hitch assembly of the trail grooming device FIG. 2 according to an embodiment of the present invention.

FIG. 14 is a perspective view of the electric winch and manual winch of the trail grooming device of FIG. 2 for raising and lowering the cutting bed according to an embodiment of the present invention.

FIG. 15 is a perspective view from the side of the roller and finish bar of the trail grooming device of FIG. 2 for compacting and finishing according to an embodiment of the present invention.

FIG. 16 is a perspective view of the front pulley configuration of the trail grooming device of FIG. 2 according to an embodiment of the present invention.

FIG. 17 is a perspective view of the rear suspension diagonal bracing of the trail grooming device of FIG. 2 according to an embodiment of the present invention.

FIG. 18 is a perspective view of the jack stand during operation of the trail grooming device of FIG. 2 according to an embodiment of the present invention.

FIGS. 19A-19C are perspective views of a V-cutter of the trail grooming device of FIG. 2 according to an embodiment of the present invention.

### DETAILED DESCRIPTION

The trail grooming device of the current invention uses a cutting bed supported by a floating suspension system, a roller and a finish bar to economically, easily and safely groom trails for recreation and travel. The cutting bed employs a plurality of small, angled V-shaped cutters located on the underside of the cutting bed. The size and geometry of the V-shaped cutters allows the grooming device to provide a large amount of force for breaking up very dense or hard chunks of ice or frozen dirt (or any other obstacle encountered) without the need for larger, heavier equipment. The floating suspension system on which the cutting bed is mounted and the angle of each V-shaped cutter also allows the cutting bed to raise up or float over immovable obstacles (e.g., rocks, stumps) that would cause damage to the groomer or injure the operator. The combination of the cutting bed, the roller bar and the finish bar allows the trail grooming device to provide a quality groomed surface in a single pass.

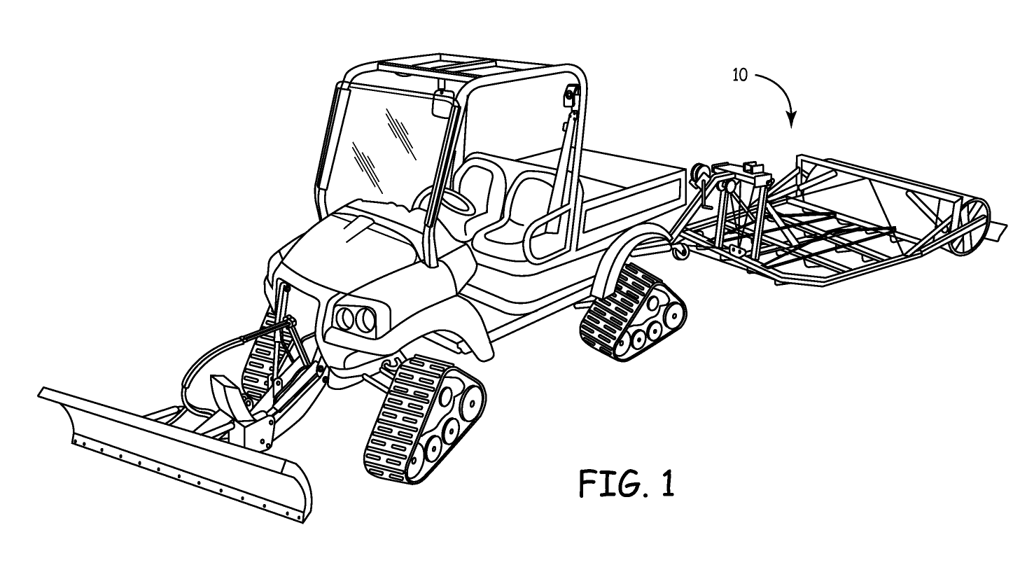

FIG. 1 is a perspective view of a trail grooming device according to an embodiment of the present invention attached to a towing vehicle. Trail grooming device 10 is connected to towing vehicle, which pulls it to groom trails. While a light-weight towing vehicle with snow tracks is shown, trail grooming device 10 can be pulled by a variety of different vehicles.

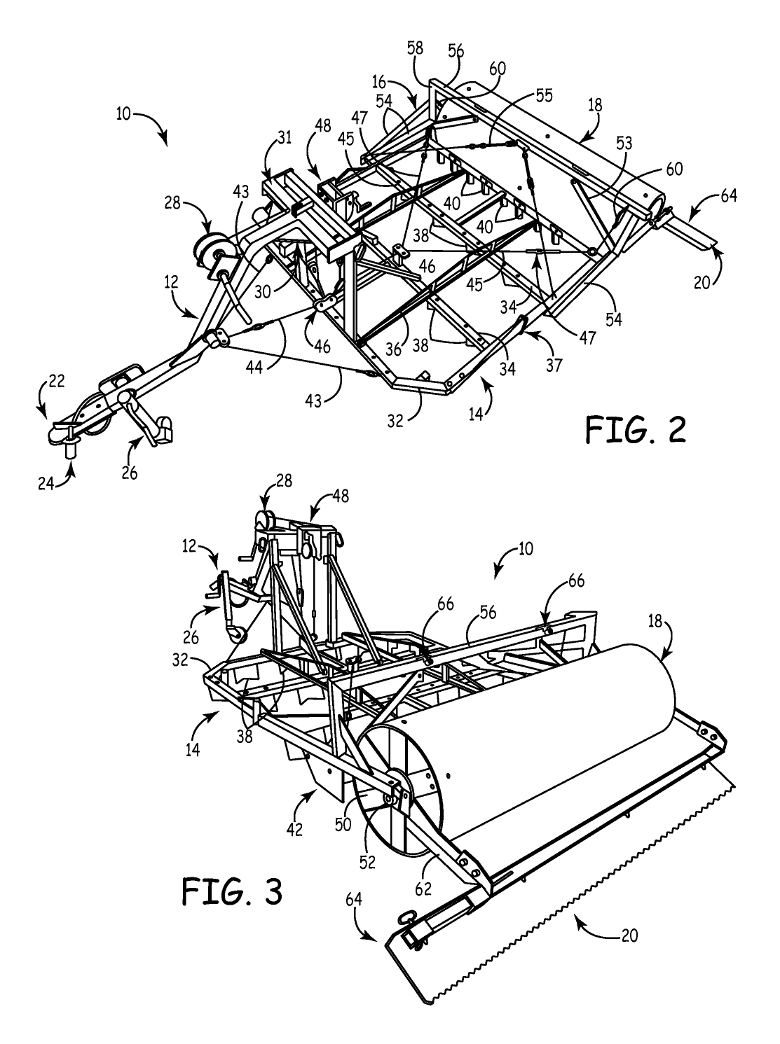

FIGS. 2-3 illustrate an embodiment of a trail grooming device according to the present invention from different perspectives. Trail grooming device 10 includes hitch assembly 12, cutting bed 14, rear suspension assembly 16, roller 18 and finish bar 20. Hitch assembly 12 includes hitch 22, 12V electrical connection 24, jack stand 26, manual winch 28 and electric winch 30. Cutting bed 14 includes frame 32, cross members 34, trusses 36, V-cutters 38, miniature V-cutters 40 and tracking skegs 42. Rear suspension assembly 16 includes swing arms 54, cross-member 56, riser tubes 58 and rubber stoppers 66.

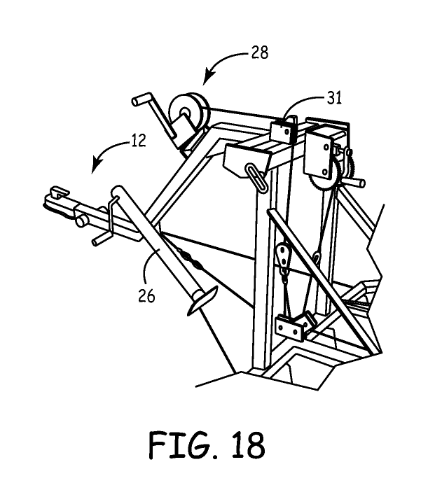

Hitch assembly 12 connects to the vehicle pulling grooming device 10 through hitch 22 and 12V electrical connection 24. When not connected to a pulling device, grooming device rests on jack stand 26. When in operation, jack stand 26 connects to a diagonal portion of hitch assembly 12 to keep the hitch from overcollapsing (see FIG. 18). Hitch assembly 12 connects to cutting bed 14 through hinge 31 (see FIGS. 8-9) and suspension system that includes cables 44, pulleys 46, manual winch 28, electrical winch 30 and rear frame winch 48. Rear suspension assembly 16 connects to cutting bed 14, roller 18 and finish bar 20. Finish bar 20 includes extension wing 64.

Cutting bed 14 cuts, levels and processes snow, ice, dirt and whatever else may be on a trail with V-cutters 38 and miniature V-cutters 40. The cutters 38, 40 are in the shape of a V, angled backwards. The angle between sides of the V in V-cutters 38 is about 110 degrees, and the angle between the sides of the V in miniature V-cutters 40 is about 90 degrees. Cutters 38, 40 are attached to cross-members 34 by bolts. Cutting bed 14 generally includes 24 or more V-cutters to ensure most surface area of a trail is cut. Each V-cutter 38 cuts a path of about 8 inches wide (but can be larger or smaller depending on needs). These V-cutters 38 and miniature V-cutters 40 hit and cut the snow with a large force (psi) due to their small individual size and without the need for a large amount of force to be provided by the vehicle pulling the device. The smaller, more numerous cutters on the current invention provide more surfaces for the cutting and re-direction of snow, delivering a large amount of force without the need for a large, heavy piece of machinery to provide extra force for the device.

Cutting bed 14 is suspended by cables 44 which run through pulleys 46 and end at manual winch 28 and electric winch 30. Cutting bed 14 is suspended in a position so that cutting bed 14 is generally level with the ground. Cable 43 connects to cutting bed 14 and hitch assembly 12 and acts to stabilize cutting bed laterally. Although a plurality of cables and pulleys are used in the suspension system, all are labeled 44 and 46, respectively, in FIGS. 2-3. The cables connect to cutting bed 14, and manual winch 28 or electrical winch 30 can then raise or lower cutting bed 14 by pulling in more cable 44 or letting out more cable 44. When cable 44 is pulled in by manual winch 28 or electric winch 30, this causes hinge 31 on hitch assembly 12 to pivot downward, raising cutting bed 14 generally uniformly with respect to the ground (see FIG. 9). When cable 44 is let out by manual winch 28 or electric winch 30, hinge 31 pivots upward, lowering cutting bed 14 generally uniformly with respect to the ground (see FIG. 8). This raising and lowering allows for adjustment of the level of cutting bed 14 as needed throughout the grooming process. This suspension system along with the angle on the V-cutters 38 and miniature V-cutters 40 provides for a much safer grooming device 10 when very hard or immovable obstacles, such as a stump or a rock, are encountered when grooming a trail. Because the trails being groomed are often covered with snow and ice, many large obstacles cannot be seen by the operator when grooming the trail. The suspension system and angle on V-cutters 38, 40 allow cutting bed 14 of the current invention to deflect or raise up and go over a difficult obstacle that trail grooming device 10 cannot cut and break up (such as a stump or a large rock). The angle of the cutters 38, 40 prevents the cutters from digging into an obstacle, which could result in damage to the grooming device, and injury to the operator, depending on the speed of grooming and the severity of the obstacle. Without the about 10 degree to about 15 degree angle of cutters 38, 40, a large obstacle could cause the cutters to dig in, resulting in a sudden stop to the groomer and vehicle pulling the groomer, possibly throwing the operator from the vehicle pulling the groomer. To address this safety issue, previous grooming devices often included a breakaway hitch or shear pins so the operator would not be injured by the force from the grooming device being caught on an obstacle. However, when this happened, the grooming device could still be damaged, and the breakaway hitch or shear pin would need to be replaced before grooming could be restarted. By floating cutting bed 14 on cables 44 and pulleys 46, cutting bed 14 is free to move up over obstacles with just the weight of cutting bed 14 on it, allowing it to move easily over obstacles that cannot be cut. Through the use of V-cutters and a suspension system, the current invention provides a high degree of safety and adaptability while allowing continuous grooming even when presented with obstacles.

Suspension system also includes a rear frame winch 48 and cables 45 which allow only the rear only of frame 32 to be raised or lowered as needed. This allows for frame 32 to be adjusted to release a buildup of snow that may pile up at the rear of frame 32 during grooming without interfering with the cutting action by V-cutters 38 on the front of frame 32. Cables 45 further include two turnbuckles 47, which allow for the adjustment of just one side of the rear of cutting bed 14. This can be used to adjust for cables stretching or to tilt cutting bed 14 to one side to form or remove a crown from a trail or road.

Cutting bed 14 also includes adjustable, slotted tracking skeg 42 attached to the rear of each side of frame 32. Tracking skeg 42 helps to prevent slippage when grooming on side hills and provide additional snow retention in the rear of cutting bed 14 so cut snow will go under roller 18 and be compacted onto trail (instead of be pushed to the side of the trail).

Rear suspension assembly 16 joins cutting bed 14 to roller 18 and finish bar 20 and generally includes a two swing arms 54 attached to cross-member 56 sitting atop riser tubes 58. Cross-member 56 provides two lifting points 60 for the raising (or lowering) of the rear of frame 32. Swing arms 54 are attached to a roller assembly with pillow bearings and provide bracing for grooming device 10. Diagonal bracing on swing arms 54 provide additional rigidity.

Roller 18 is attached to rear suspension assembly 16 by four spiders 50 (one on each end of roller 18 and two spaced evenly inside, only one can be seen in FIG. 3), each with a hub 51 and an axle 52. Each spider 50 includes a hub 51 which is attached to an axle 52 (see FIG. 15) and is connected to roller 18 by L-shaped brackets. Roller 18 compacts the snow that has been cut, leveled and processed by cutting bed 14, producing a smooth surface. In the embodiment shown, roller 18 is a ¾ inch, smooth-walled high-density polyethelene (“HDPE”) pipe with a 24 inch outside diameter. The HDPE pipe is extremely durable, does not corrode or leave any residue (rust), can withstand high mileage and compacts the snow smoothly and well due to its heavy weight (around 180 lbs for the embodiment shown). Snow will also not stick to the HDPE pipe, helping ensure a smooth finish. HDPE pipe is also more economical and lighter in weight than similarly suited alternatives, such as steel. While the embodiment shown is ¾ inch HDPE pipe with a 24 inch diameter, roller 18 can be a different size or made of different similarly suited materials which allow the roller to hold its shape and compact the trail. Roller 18 is generally the same width as frame 32. The large diameter and weight allow roller 18 to compact the cut snow, ice and dirt, leaving a smooth surface.

Finish bar 20 screeds the snow (or ice or dirt) compacted by roller 18 to give it a finished appearance. Finish bar 20 is a piece of metal with small cutouts of about 45 degrees at about every inch. Finish bar 20 is made of L-shaped ⅛ inch thick rectangular steel section bent about 3 inches by about 9 inches. It is generally the same width as cutting bed 14 (and roller 18). Finish bar 20 is attached to two arms 62 which are attached to rear suspension assembly 16 and drags over the snow. The angle at which finish bar 20 is drug over the snow can be changed based on the condition of snow and desire of finished appearance. For example, when snow is older and harder, finish bar 20 can be angled downward more to scratch into the snow to form ridges, whereas when snow is new and light, a shallower angle may achieve the desired finish. Finish bar 20 provides a uniform, corduroy like surface for the trail. Finish bar 20 can help to give the trail more horizontal grip as well, helping prevent glazing or icing up of the trail (a problem in cross-country ski trails). Finish bar 20 further includes an extension wing 64 that quickly and easily attaches to one or both sides of finish bar 20 to extend the width of finishing beyond the width of cutting bed 14 and roller 18. This can help to minimize the ridge line during multiple passes. When trail grooming device 10 is not in use, or when finishing is not desired, finish bar 20 can swing up on arms 62 to rest finish bar 20 against rubber stoppers 66 on rear suspension assembly 16. This allows finish bar 20 to be conveniently out of the way, and rubber stoppers 66 prevent finish bar 20 from rattling against rear suspension assembly 16.

Trail grooming device 10 can be easily compacted for transport, shipping or storage when not in use. Quick pins 23 (shown in FIG. 3) are located where hitch assembly 12 attaches to cutting bed 14. Releasing quick pins 23 allows bracing arms 25 to fold down onto cutting bed 14. Finish bar 20 can fold up and rest against rubber stoppers 66 on rear suspension assembly 16. Rear suspension assembly 16 can detach from cutting bed 14, and swing arms 54 can fold in. Cutting bed 14 frame 32 includes a joint 37 to fold in half for transport, shipping or storage. All cables include a quick release (quick pin) for compaction. Once hitch assembly 12 is detached, cutting bed is folded, and rear suspension assembly 16 is detached with finish bar 20 folded up, trail grooming device can be transported or stored in a much smaller amount of space than when fully assembled (about ⅕ of the length). Because quick pins are used, trail grooming device can be quickly and easily reassembled.

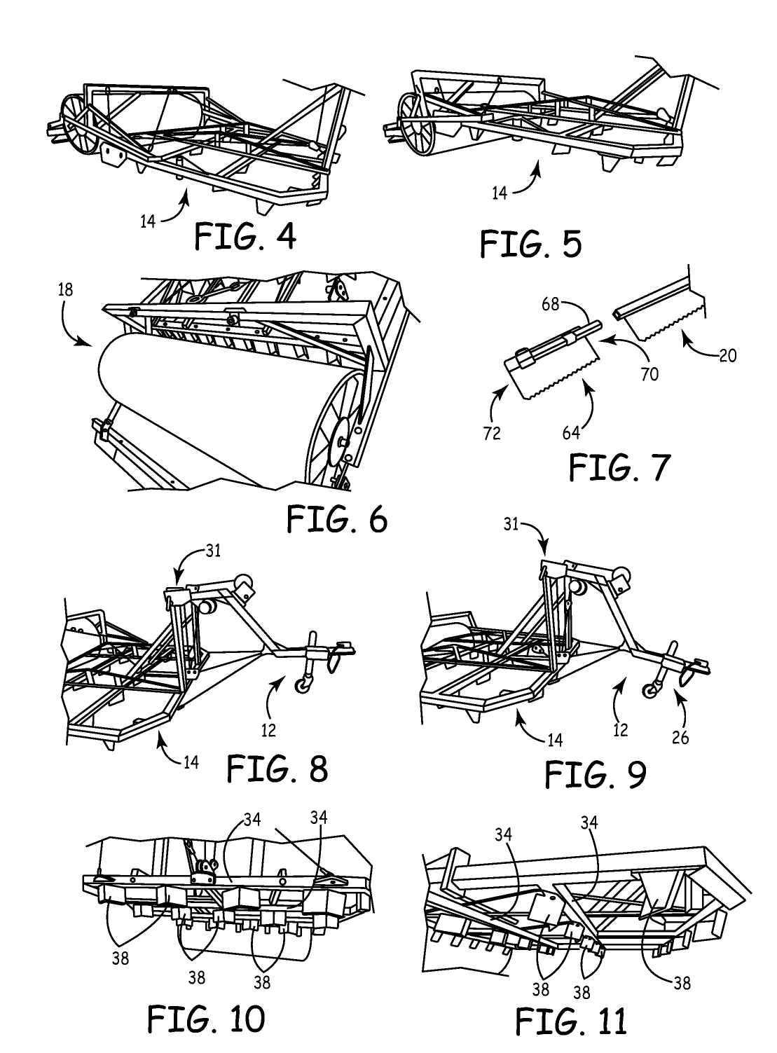

FIGS. 4-5 are perspective views of a cutting bed of the trail grooming device of FIG. 2 in a lowered position and a semi-raised position, respectively, according to an embodiment of the present invention. FIG. 4 shows cutting bed 14 of trail grooming device 10 in a lowered position. FIG. 5 shows the cutting bed of trail grooming device 10 in a semi-raised position. Cutting bed 14 is raised and lowered through either electric winch 30 or manual winch 28 pulling in or letting out cables 44 (which run through pulleys 46) causing hinge 31 to bend and cutting bed 14 to raise or lower generally uniformly with respect to the ground. In the embodiment shown, cutting bed 14 can be raised about 16 inches above the ground level.

FIG. 6 is a perspective view of a roller and miniature V-cutters of the trail grooming device of FIG. 2 according to an embodiment of the present invention. Miniature V-cutters 40 sit very close to roller 18, and work to cut and break up snow, ice and dirt on the trail before roller compacts it. Miniature V-cutters 40 are similar in design to V-cutters 38, just scaled down. This helps to further break down and cut snow, ice and dirt which have been cut by V-cutters 38 to further aid in compaction and grooming.

FIG. 7 is a perspective view of an extension wing for attachment to a finishing bar of the trail grooming device of FIG. 2 according to an embodiment of the present invention. Extension wing 64 can attach to one or both sides of finish bar 20. As can be seen in FIG. 7, extension wing 64 includes a bar 68 that can slide out first side 70 to attach extension wing 64 to one side of finish bar 20, or it can slide out a second side 72 (not shown sliding out that side) to attach extension wing 64 to the other side of finish bar 20. Sliding bar 68 is held in place by a pin. As mentioned above, extension wing extends the width of finishing beyond the width of cutting bed 14 and roller 18 to minimize the ridge line during multiple passes.

FIGS. 8-9 are perspective views of the hinge action of the hitch assembly of the trail grooming device of FIG. 2 according to an embodiment of the present invention. FIG. 8 shows hinge 31 action of hitch assembly 12 of trail grooming device 10 when the cutting bed is in a lowered position. FIG. 9 shows hinge 31 action of hitch assembly 12 of trail grooming device 10 when the cutting bed is in a semi-raised position. Electric winch 30 or manual winch 28 can be used to raise cutting bed 14 through a series of cables 44, pulley 46, and hinge 31 of hitch assembly 12.

FIGS. 10-11 are perspective views showing the location and geometry of V-cutters employed by the trail grooming device of FIG. 2 according to an embodiment of the present invention. As can be seen in FIGS. 10-11 a plurality of evenly spaced V-cutters 38 are bolted onto cross-members 34 to provide cutting action when trail grooming device 10 is in operation. As can be seen in FIG. 11, V-cutters 38 are placed at different positions relative the sides of frame 32 on each respective cross member 34 to ensure the entire width of the trail is cut by V-cutters 38.

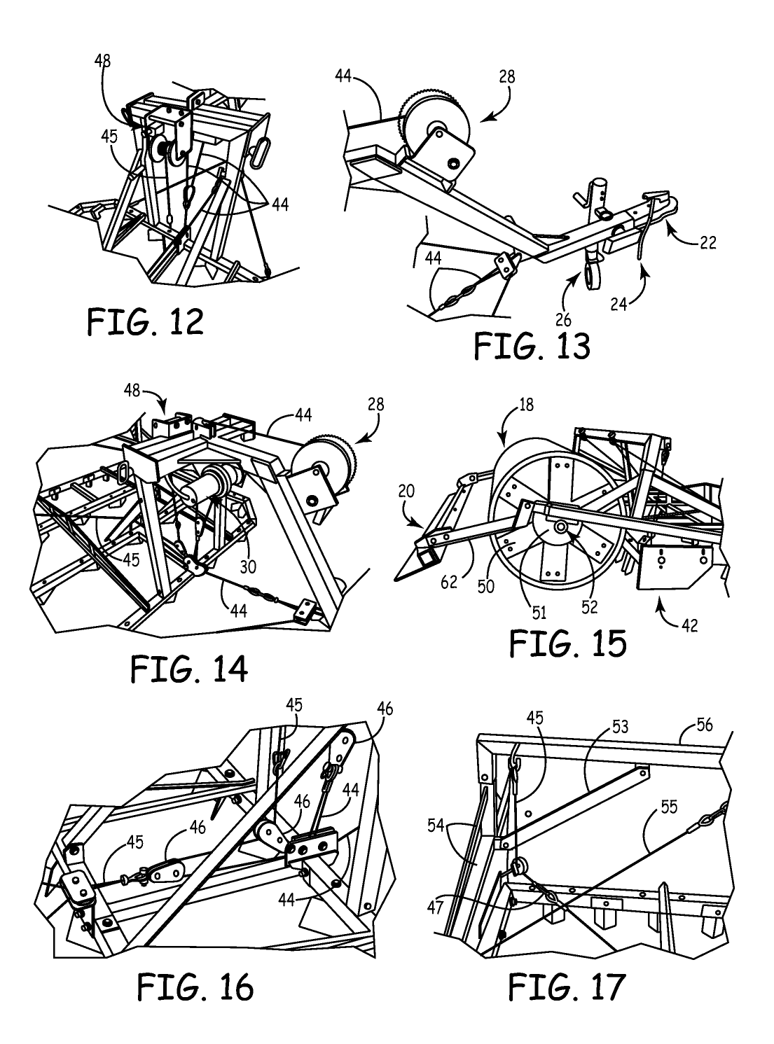

FIG. 12 is a perspective view of the rear frame winch of the trail grooming device of FIG. 2 for raising and lowering the rear of the cutting bed according to an embodiment of the present invention. Rear frame winch 48 is connected to cable 45, allowing it to raise and lower just the rear of cutting bed 14. Cables 44 running to manual winch 28 and electric winch 30 to raise and lower cutting bed 14 can also be seen from this view.

FIG. 13 is a perspective view of the hitch assembly of the trail grooming device FIG. 2 according to an embodiment of the present invention. This view includes hitch 22, electric connection 24, jack 26 and manual winch 28. Hitch 22 provides a standard mechanical connection to a towing vehicle. Electric connection 24 distributes electrical power from the towing vehicle to grooming device 10 to operate electric winch 30.

FIG. 14 is a perspective view of the electric winch and manual winch of the trail grooming device of FIG. 2 for raising and lowering the cutting bed according to an embodiment of the present invention. Manual winch 28 or electric winch 30 can be used to raise or lower cutting bed 14. Electric winch 30 is convenient for raising and lowering cutting bed 14 from the operating vehicle without have to physically go to trail grooming device 10 to raise or lower cutting bed 14. This can be done with a button or switch that is remotely connected or connected by wires and cables to electric winch 30. Manual winch 28 can be used when no electric connection is available, or if electric connection is malfunctioning.

FIG. 15 is a perspective view from the side of the roller and finish bar of the trail grooming device of FIG. 2 for compacting and finishing according to an embodiment of the present invention. This side view includes tracking skeg 42, finish bar 20, roller 18 with spider 50 with a hub 51 and an axle 52. Each of the six “legs” of spider 50 is attached to roller 18 by L-shaped brackets. Bolting roller 18 to spider 50 with brackets helps to ensure roller 18 is close to perfectly round (as HDPE pipe is often not perfectly round when made) to leave a smooth trail and aid in smooth operation of trail grooming device 10. Each roller 18 will include four spiders 50 bolted to roller 18, each with a hub 51 attached to axle 52. They will be spaced evenly, with one on each side, and two evenly spaced in the middle, one at ⅓ of the length of roller 18 from a first end and another at ⅔ of the length of roller 18 from the first end. Four spiders help ensure roller 18 stays very close to perfectly round throughout the length and ensures a sturdy connection between roller 18 and axle 52.

FIG. 16 is a perspective view of the front pulley configuration of the trail grooming device of FIG. 2 according to an embodiment of the present invention. This pulley configuration helps to allow cutting bed 14 to be raised up or down (generally uniformly with respect to the ground) with cables 44, pulleys 46 and winches 28, 30. It also allows just the rear of cutting bed 14 to be raised or lowered by cables 45, pulleys 46 and rear frame winch 48.

FIG. 17 is a perspective view of the rear suspension diagonal bracing of the trail grooming device of FIG. 2 according to an embodiment of the present invention. This view includes cable 45, turnbuckle 47, swing arms 54, rear suspension cross-member 56, riser tube 58, diagonal bracing 53 and stabilizing cable 55. Diagonal bracing 53, swing arms 54 and stabilizing cable 55 help to stabilize rear suspension cross-member 56. Turnbuckle 47 allows for adjustment of the cables to either compensate for cable stretching, or to tilt cutting bed 14 to one side, which may be desirable to form or remove a crown from a trail.

FIG. 18 is a perspective view of the jack stand during operation of the trail grooming device of FIG. 2 according to an embodiment of the present invention. As mentioned above, when in operation, jack stand 26 connects to hitch assembly to keep frame 32 from overcollapsing. Jack stand 26 would stop the hinge of hitch assembly 12 (see FIGS. 8-9) from over pivoting and allowing frame 32 to come in contact with hitch assembly 12.

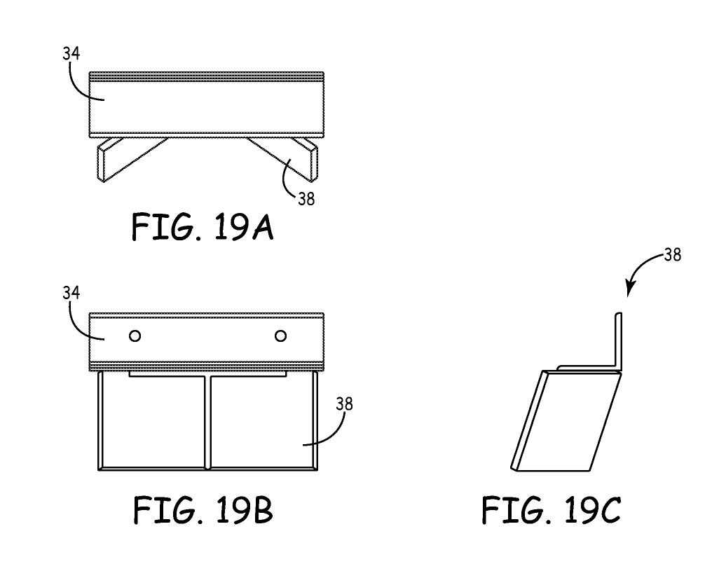

FIGS. 19A-19C are perspective views of a V-cutter of the trail grooming device of FIG. 2 according to an embodiment of the present invention. FIG. 19A is a perspective view from behind and above V-cutter 38. This view illustrates that the angle between sides of the V in V-cutters 38 is about 110 degrees. Although not shown in FIG. 19A, the angle between the sides of the V in miniature V-cutters 40 is about 90 degrees. FIG. 19B is a perspective view from the front of V-cutter 38. V-cutters 38, 40 are attached to cross-member 34 by bolts, and each V-cutter 38 clears a path of about 8 inches wide. FIG. 19C is a perspective view of the side of V-cutter 38. This view illustrates how V-cutter 38 (and miniature V-cutters 40) sweeps back at an angle of about 10 to about 15 degrees. Dimensions given are for example purposes only, and may vary depending on needs of individual trail grooming device 10.

One advantage of the trail grooming device of the current invention is the versatility and adaptability of the device. For example, upon a new snowfall, cutting is not always required and it is sometimes desirable to only roll the snow. The trail grooming device of the current invention allows for this, as the cutting bed can be raised by the electric winch or the manual winch, and the finishing bar can be folded up so only the roller is going over the trail. It is also highly adjustable to varying terrain which may be encountered while grooming. The cutting bed can be raised and lowered during the grooming process. Furthermore, the current invention allows for the raising or lowering of only the rear of the cutting bed if that is desired. The cutting bed can also be tilted side to side to form or remove a crown from a trail or road by adjusting the length of certain cables in the suspension.

Another advantage of this trail grooming device is the ease of operation as well as storage. It can be pulled with small vehicles, such as ATV's, snowmobiles, etc., or can even be pulled with a small pickup truck. The only requirement for the vehicle pulling the trail grooming device is that it has a connection device suitable for connecting to the front hitch assembly of the trail grooming device. Although there is a 12V electrical connection, it is not necessary to have a vehicle with an electric connection. If there is no electric connection on the vehicle pulling the grooming device, the manual winch can be used to raise or lower the cutting bed instead of the electrical winch. The use of smaller vehicles to pull the grooming device also allows it to be highly maneuverable and groom areas where larger, heavier vehicles (needed to pull other groomers) could not go. This also makes the grooming device more economical, as a lighter-weight vehicle will require less fuel to operate when grooming trails. As discussed in relation to FIGS. 2-3, the trail grooming device of the current invention can be compacted for easy transport, shipping or storage. It can also be easily and quickly reassembled due to the use of quick pins.

A further advantage of the trail grooming device of the current invention is the safety provided by the suspension system for the cutting bed and the angle of the cutters. When the trail grooming device encounters a hard obstacle which it cannot cut, it will simply go up and over the obstacle. Due to the angle of the cutters and the suspension system, the trail grooming device will not get stuck on the obstacle (which could result in damaging the device and injuring the operator).

In summary, the trail grooming device of the current invention provides a safe, versatile, economical and very effective way to groom snow, ice, dirt (and whatever else may be present) on trails through the combination of a suspended, height-adjustable cutting bed with a plurality of small V-cutters, a roller and a finishing bar. The multiple small V-cutters provide effecting cutting, level and processing of the snow by delivering high powered cutting force through their compact size. The suspension allows versatility when grooming and safety when encountering obstacles that cannot be cut. The roller provides effective compaction, and the finish bar provides a finished uniform surface.

While the trail grooming device of the current invention has been discussed mostly in relation to winter groom of ice and snow, it can also be used to groom other surfaces such as dirt or sand.

Computer-aided design (“CAD”) drawings of an embodiment of the present invention as well as parts of an embodiment of the present invention are provided in appendix A.

While the invention has been described with reference to an exemplary embodiment(s), it will be understood by those skilled in the art that various changes may be made and equivalents may be substituted for elements thereof without departing from the scope of the invention. For example, a sensor could be added so that cutting bed (or only one side of cutting bed) could raise or lower automatically upon detecting a change in terrain while grooming or upon detecting a snow buildup at the back. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A trail grooming device connectable to a towing vehicle so that the towing vehicle can pull the device over a surface, the device comprising:
a connection assembly that connects the device to the vehicle;
a cutting bed to cut, level and process the surface and with a front portion connected to the connection assembly;
a suspension system coupled to the cutting bed to raise or lower the cutting bed;
a rear assembly connected to a rear portion of the cutting bed; and
a roller connected to the rear assembly to compact the surface after the cutting bed has cut, leveled and processed the surface.

2. The device of claim 1, wherein the connection assembly further comprises:
a hitch assembly to connect the device to the vehicle;
a hinge connected between the hitch assembly and the front portion of the cutting bed to allow the cutting bed to be raised or lowered by the suspension system.

3. The device of claim 2, and further comprising:
a jack stand for supporting the device when not connected to the vehicle.
wherein when the grooming device is connected to the vehicle, the jack stand connects to the hitch assembly at an angle to prevent the hitch assembly from overcollapsing.

4. The device of claim 1, wherein the cutting bed further comprises:
an outer frame;
a plurality of cross members attached to the outer frame; and
a plurality of V-shaped cutters attached to the cross members and angled backwards to cut, level and process the surface.

5. The device of claim 4, wherein a first portion of the V-shaped cutters are larger than a second portion of the V-shaped cutters.

6. The device of claim 5, wherein the first portion of V-shaped cutters are positioned on cross members located near the front portion of the cutting bed and the second portion of V-shaped cutters are located on cross members at the rear portion of the cutting bed.

7. The device of claim 4, wherein the V-shaped cutters are offset from the V-shaped cutters connected to other cross members so that the V-shaped cutters can cut, level and process the most surface area as the cutting bed moves over a surface.

8. The device of claim 1, wherein the suspension assembly further comprises:
a plurality of pulleys;
a plurality of cables running through the pulleys and connected to the cutting bed, the connection assembly and the rear assembly;
a first winch to raise or lower the cutting bed through pulling in or letting out cable.

9. The device of claim 8, and further comprising:
a second winch to raise or lower the cutting bed.

10. The device of claim 9, wherein the first winch is a manual winch and the second winch is an electric winch.

11. The device of claim 9, and further comprising:
a third winch to raise or lower the rear portion of the cutting bed.

12. The device of claim 9, wherein either of the first winch or the second winch can be used to raise or lower the cutting bed while keeping it about parallel to the surface.

13. The device of claim 1, wherein the suspension system is able to raise or lower the cutting bed while keeping the cutting bed about level with the surface.

14. The device of the claim 1, wherein the suspension system allows the cutting bed to raise up to go over obstacles that cannot be cut, leveled or processed by the cutting bed.

15. The device of claim 1, wherein the roller is high-density polyethelene pipe.

16. The device of claim 1, and further comprising:
a finish bar connected to the roller to give the compacted surface a desired finish.

17. The device of claim 16, wherein the finish bar further comprises:
an extension to increase the length of the finish bar so that the finish bar contacts a wider section of the surface than the roller contacts.

18. The device of claim 1, and further comprising:
a plurality of tracking skegs connected to the outer frame of the cutting bed to prevent slippage when grooming on surfaces not level and to contain cut, leveled and processed surface material under roller.

19. A trail grooming apparatus comprising:
a connection assembly that connects the device to the vehicle;
a cutting bed with a plurality of V-shaped cutters to cut, level and process the surface and with a front portion connected to the connection assembly; and
a suspension system coupled to the cutting bed to raise or lower the cutting bed and to allow the cutting bed to raise up and go over obstacles that cannot be cut, leveled or processed.

20. A surface grooming device to attach to a vehicle which pulls the device over a surface; the device comprising:
a connection assembly including a hitch assembly to connect device to vehicle, and a hinge to allow the hitch to pivot;
a cutting bed to cut, level and process the surface and with a front portion connected to the connection assembly through the hinge, the cutting bed including an outer frame, a plurality of cross members attached to the outer frame and a plurality of V-shaped cutters attached to the cross members and angled backwards to cut, level and process the surface;
a suspension system to raise or lower the cutting bed with a plurality of pulleys; a plurality of cables running through the pulleys and connected to the cutting bed, the connection assembly and the rear assembly; and a winch to raise or lower the cutting bed through pulling in or letting out cable;
a rear assembly connected to a rear portion of the cutting bed; and
a roller connected to the rear assembly to compact the surface after the cutting bed has cut, leveled and processed the surface; and
a finish bar connected to the roller to give the surface a desired finish.
